(19) United States
(12) Patent Application Publication
(10) Pub. No.: US 2009/0326937 A1
(43) Pub. Date: Dec. 31, 2009

(54) USING PERSONALIZED HEALTH INFORMATION TO IMPROVE SPEECH RECOGNITION

(75) Inventors: Behrooz Chitsaz, Bellevue, WA (US); Hong Choing, Collegeville, PA (US); Alexander G. Gounares, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/106,497

(22) Filed: Apr. 21, 2008

(51) Int. Cl. G10L 15/26; G06F 17/30

(52) U.S. Cl. 704/235; 707/3; 704/E15.043; 707/E17.001

(57) ABSTRACT

The claimed subject matter provides systems and/or methods that improve speech recognition in the medical context. The system includes mechanisms that access personal health records associated with patients and/or analyze the personal health records for current diseases and/or past ailments. The system thereafter acquires attributes associated with the diseases or ailments and dynamically populates a speech model with these attributes. The speech model utilizes the attributes associated with the diseases or ailments to more accurately transcribe a voice pattern into text that can be projected on a visual display or persisted to a storage device.

### BACKGROUND

Conventional mechanisms for entering and collecting information through use of keyboards, tablets, light pens, mice, and the like diverts the medical practitioner's attention away from the task at hand; medical practitioners typically have their hands otherwise occupied examining the patient so speech can be a more effective way of capturing the results of the examination in real time. Nevertheless, current speech recognition engines are not sufficiently accurate to correctly capture utterances by humans for use in the medical field and hence those practitioners who do dictate results of their examinations send them to transcription agencies for transcription, a service that can be expensive. Moreover, in the medical profession there can also be professional and legal requirements that patient details be adequately documented which can entail such details being entered or input into databases and/or other machines.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with an aspect provides systems and methods that improve speech recognition. The systems and methods disclosed herein can acquire personal health records associated with a patient and utilize the patient's past and/or current illnesses to contextually load or populate an aspect of a speech or voice recognition component with contextual attributes associated with the past and current ailments. The speech or voice recognition component in concert with the acquired personal health records, derived or determined contextual attributes and/or information gleaned from a patient's past and/or current ailments, and/or industry specific repositories can transcribe voice input into text form for display and/or storage and subsequent utilization.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that improves speech recognition by utilizing a patient's health records in accordance with the claimed subject matter.

FIG. 2 depicts machine-implemented system that effectuates and facilitates speech recognition based at least in part on personal health records associated with a patient in accordance with an aspect of the claimed subject matter.

FIG. 3 provides a more detailed depiction of an illustrative analysis engine that effectuates and facilitates speech recognition based at least in part on personal health records associated with a patient in accordance with an aspect of the claimed subject matter.

FIG. 4 illustrates a system implemented on a machine that effectuates and facilitates speech recognition based at least in part on personal health records associated with a patient in accordance with an aspect of the claimed subject matter.

FIG. 5 provides a further depiction of a machine implemented system that effectuates and facilitates speech recognition based at least in part on personal health records associated with a patient in accordance with an aspect of the subject matter as claimed.

FIG. 6 illustrates yet another aspect of the machine implemented system that effectuates and facilitates speech recognition based at least in part on personal health records associated with a patient in accordance with an aspect of the claimed subject matter.

FIG. 7 depicts a further illustrative aspect of the machine implemented system that effectuates and facilitates speech recognition based at least in part on personal health records associated with a patient in accordance with an aspect of the claimed subject matter.

FIG. 8 illustrates another illustrative aspect of a system implemented on a machine that effectuates and facilitates speech recognition based at least in part on personal health records associated with a patient in accordance of yet another aspect of the claimed subject matter.

FIG. 9 depicts yet another illustrative aspect of a system that effectuates and facilitates speech recognition based at least in part on personal health records associated with a patient in accordance with an aspect of the subject matter as claimed.

FIG. 10 illustrates a flow diagram of a machine implemented methodology that effectuates and facilitates speech recognition based at least in part on personal health records associated with a patient in accordance with an aspect of the claimed subject matter.

FIG. 11 illustrates a block diagram of a computer operable to execute the disclosed system in accordance with an aspect of the claimed subject matter.

FIG. 12 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

The claimed subject matter in accordance with an aspect utilizes personal health information and patient history information to provide contextual data for voice recognition processing. The use of such contextual information can greatly improve the accuracy and efficiency of the data entry process. Moreover, in a further aspect, smart forms can utilize contextual data to further increase voice recognition accuracy in the medical context, for example.

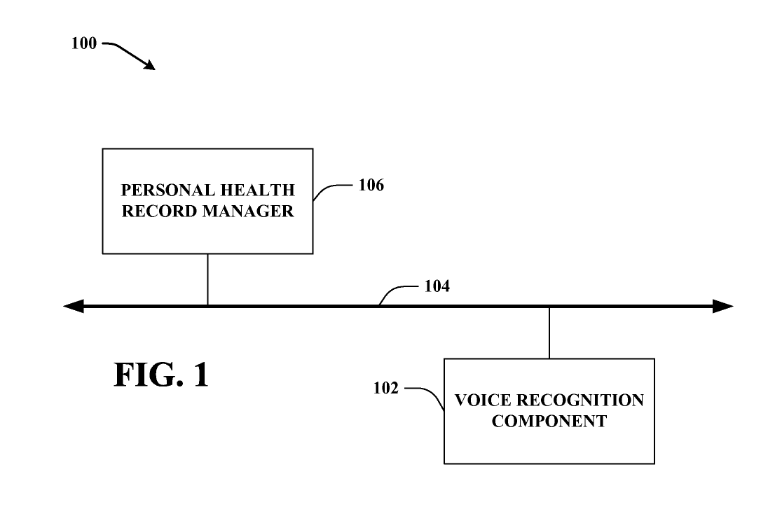

FIG. 1 provides illustration of a machine implemented system that improves speech recognition based at least in part on personal health records associated with a patient. System 100 can include voice recognition component 102 that can acquire voice input (e.g., via microphone associated with voice recognition component 102, or audio files persisted on associated storage media, . . . ) from medical personnel (e.g., doctors, nurses, laboratory technicians, etc.), medical or health related records associated with a particular patient from personal health record manager 106, and one or more standard medical attributes (e.g., codes from the International Statistical Classification of Diseases and Related Health Problems, commonly referred to as ICD codes) from one or more repositories typically dispersed over a network topology or cloud 104 (e.g., the Internet, extranets, intranets, etc.) or locally associated with voice recognition component 102.

Voice recognition component 102 can, not only, dynamically adjust and differentiate the speech model utilized based at least in part on the user of the system (e.g., Doctor 1, Doctor 2, Nurse A, Nurse B, Laboratory Technician X, . . . ), but can also automatically modify the speech model based at least in part on the functions carried out by the user of the system (e.g., a speech model appropriate to First Year Medical Intern, Surgical Oncologist, Pathology Laboratory Technician, and the like, can be respectively loaded). Additionally, voice recognition component 102 can also dynamically and/or automatically adapt, restructure, or reconstruct the voice or speech model based at least in part on characteristics or attributes particular or peculiar to medical or health records retrieved or received from personal health record manager 106 and associated with an individual patient.

Moreover, voice recognition component 102 can also appropriately format (e.g., transcribe) recognized speech into a standard or prescribed format (e.g., the format adopted can be prescribed by international standard, a professional standard, a hospital standards, etc.). For example, doctors, nurses, or lab technicians, can each enunciate or express attributes or characteristics associated with a particular disease in different, but equally valid, ways which occasionally can lead to confusion and mistake. For instance, doctors trained in Europe can enumerate a disease according to one set of criteria, doctors trained in South America can enumerate the same disease according to a different set of criteria, and doctors trained in Asia can enumerate the same disease in accordance with yet another disparate but equally valid set of criteria. These disparate enumerating methodologies, as will be readily comprehended, can lead to misunderstanding and ultimately medical mistake. Thus, in order to mitigate mistake and reduce confusion amongst medical professionals, voice recognition component 102 can convert recognized speech into a standardized consistent format so that all parties that deal with the transcribed text can be assured of a commonality of understanding based on an easily understood standardized and universally comprehended formatting structure.

As illustrated, voice recognition component 102 can be in continuous and/or operative, or intermittent but sporadic communication with personal health record manager 106 via network topology and/or cloud 104. Voice recognition component 102 can be implemented entirely in hardware and/or a combination of hardware and/or software in execution. Further, voice recognition component 102 can be incorporated within and/or associated with other compatible components. Moreover, voice recognition component 102 can be any type of machine that includes a processor and/or is capable of effective communication with personal health record manager 106 and network topology and/or cloud 104. Illustrative machines that can comprise voice recognition component 102 can include cell phones, smart phones, laptop computers, notebook computers, Tablet PCs, consumer and/or industrial devices and/or appliances, hand-held devices, personal digital assistants, server class machines and/or computing devices and/or databases,, multimedia Internet enabled mobile phones, multimedia players, automotive components, avionics components, and the like.

Network topology and/or cloud 104 can include any viable communication and/or broadcast technology, for example, wired and/or wireless modalities and/or technologies can be utilized to effectuate the claimed subject matter. Moreover, network topology and/or cloud 106 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, network topology and/or cloud 104 can include or encompass communications or interchange utilizing Near-Field Communications (NFC) and/or communications utilizing electrical conductance of the human skin, for example.

Personal health record manager 106 can be an online repository and/or directed search facility that persists or stores an individual's health data ranging from test results to physician's reports to daily measurements of weight or blood pressure. Individuals can then have access to their records at any time, anywhere, via network topology and/or cloud 104 and utilization of voice recognition component 102. Affiliated medical practitioners, medical offices, and/or hospitals can, for instance, easily forward test results in digital form to personal health record manager 106, and individuals (e.g. patients) can in turn authorize selected medical practitioners, medical offices, hospitals, components owned or controlled by the individual, and the like, to access various carefully circumscribed aspects of their personal data. Additionally and/or alternatively, personal health record manager 106 can also provide directed and/or targeted vertical search capabilities that can provide more relevant results than generalist search engines. For instance, a search actuated on personal health record manager 106 can allow individuals to specifically tailor their search queries based on their persisted health records, past queries, and the like, and can receive in return results that are most relevant to each individual's situation. Personal health record manager 106, like voice recognition component 102, can be implemented entirely in hardware and/or as a combination of hardware and/or software in execution. Further, personal health record manager 106 can be any type of engine, machine, instrument of conversion, or mode of production that includes a processor and/or is capable of effective and/or operative communications with network topology and/or cloud 104, and/or voice recognition component 102. Illustrative instruments of conversion, modes of production, engines, mechanisms, devices, and/or machinery that can comprise and/or embody personal health record manager 106 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

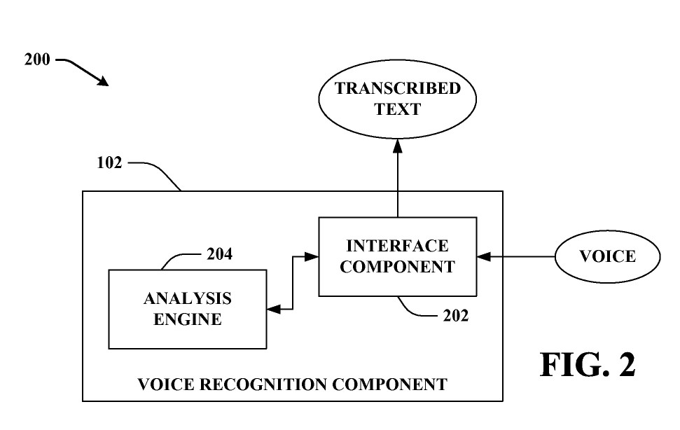

FIG. 2 provides more detailed illustration 200 of voice recognition component 102 in accordance with an aspect of the claimed subject matter. Voice recognition component 102, as depicted, can include interface component 202 (hereinafter referred to as “interface 202”) that can receive and/or disseminate, communicate, and/or partake in data interchange with a plurality of disparate sources and/or components. For instance, interface 202 can receive and/or transmit data from, or to, a multitude of sources, such as, for example, data associated with health records obtained from personal health manager 106 or information related to standardized codes and formats acquired or received from a multitude of associated repositories. Additionally and/or alternatively, interface 202 can obtain and/or receive data associated with usernames and/or passwords, sets of encryption and/or decryption keys, client applications, services, users, clients, devices, and/or entities involved with a particular transaction, portions of transactions, and thereafter can convey the received or otherwise acquired information to analysis component 204 for subsequent utilization, processing, and/or analysis. To facilitate its objectives, interface 202 can provide various adapters, connectors, channels, communication pathways, etc. to integrate the various components included in system 200 into virtually any operating system and/or database system and/or with one another. Additionally and/or alternatively, interface 202 can provide various adapters, connectors, channels, communication modalities, and the like, that can provide for interaction with the various components that can comprise system 200, and/or any other component (external and/or internal), data, and the like, associated with system 200.

Voice recognition component 102 can also include analysis engine 204 that can utilize input received by interface 202 to automatically adapt and differentiate the speech model employed based at least in part on who is utilizing voice recognition component 102. For example, if Doctor Wu is using voice recognition component 102 to dictate the diagnosis of Patient Su, a speech model that includes aspects of Doctor Wu's speech patterns together with diagnostic aspects associated with Patient Su's past and current medical conditions can be utilized, similarly, where Doctor Koo is using voice recognition component 102 to dictate the treatment of Patient Lim, a speech model specific to Doctor Koo together with contextual aspects associated specifically with Patient Lim (e.g., characteristics from Patient Lim's health records gleaned from personal health record manager 106) can be loaded and utilized by analysis engine 204 during Doctor Koo's dictation session.

Further, analysis engine 204 that can dynamically and automatically modify the speech model utilized based at least in part on the functions of the persons utilizing voice recognition component 102. For instance, where Doctor Kumar is a neurosurgeon and Doctor Acheampong is an urologist the speech model can be selectively adapted according to each of Doctor Kumar and Doctor Acheampong's functional specialties (e.g., neurology and urology, respectively). Additionally and/or alternatively, analysis engine 204 can dynamically or spontaneously reconstruct or restructure the speech model based at least in part on a perceived experience level associated with each medical professional. For example, Nurse Betty can have just graduated from nursing school, Doctor Büincen can be a second year medical resident, and Inna Petri-Dish can be head of the hospital pathology laboratory, accordingly, analysis engine 204 can provide speech models commensurate both with each of Nurse Betty, Doctor Büincen, and Inna Petri-Dish's experience level as well as each of their respective functionalities. Further, analysis engine 204 can also adaptively modify incoming speech (e.g., while the individual is speaking, while an audio file is being played back, . . . ) in order to conform with a prescribed standard, to mitigate against mistake or misunderstanding, and/or to avoid unnecessary confusion in terminology.

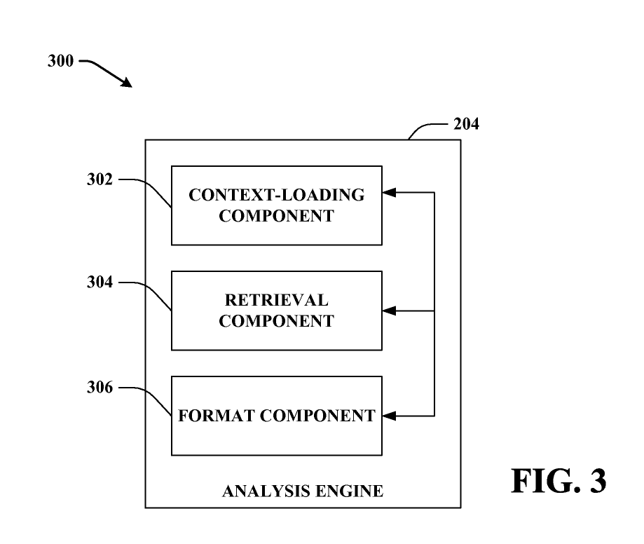

FIG. 3 provides a more detailed depiction 300 of analysis engine 204 in accordance with an aspect of the claimed subject matter. As illustrated analysis engine 204 can include context loading component 302 that can instigate personal health record manager 106 to download health records associated with a particular patient. Based at least in part on these health records context loading component 302 can load speech models contextually specific to the patient of concern (e.g., attributes, artifacts, and characteristics specific to past and current illnesses of the individual patient can be associated with the loaded speech model). As will be appreciated, since no two patients will necessarily have the same set of symptomatologies or, for that matter, will visit his or her physician at the same time or on the same day as any other patient, the speech model for each and every patient whose records are obtained and utilized by context loading component 302 will be individuated based at least in part on the patient's health records. Moreover, as will be further appreciated, and as evidence of the dynamism of the claimed subject matter, the contextual model utilized by Doctor X today to dictate notes regarding Patient Y will not necessarily be the same contextual model employed by Doctor X to dictate notes regarding Patient Y tomorrow. For instance and in furtherance of the foregoing illustration, in the interim between the Doctor X's two visitations to Patient Y, a pathology report and associated dictated commentary (e.g., utilizing the claimed subject matter) from the hospital pathology laboratory can have been added to Patient Y's health records persisted in personal health record manager 106. Thus, when Doctor X sees Patient Y the second time, the speech model utilized will be contextually and adaptively distinct from the speech model initially employed the first time that Doctor X saw Patient Y. Moreover, when Doctor X moves onto to treat Patient Z, contextual loading component 302 can substitute speech models that specifically and contextually relate solely to Patient Z (e.g., the speech model inclusive of the contextual aspects associated with Patient Y can be swapped out for a speech model unique to Patient Z including contextual aspects specific to Patient Z; contextual artifacts associated with Patient Y and Patient Z are generally not intermingled).

In addition to context loading component 302, analysis engine 204 can also include retrieval component 304 that, in accordance with an aspect of the claimed subject matter, can facilitate and/or effectuate a search of network topology and/or cloud 104 to locate one or more standard medical attributes (e.g., codes associated with ICD-9, ICD-10, ICD-11, . . . ) that can be utilized to populate the speech model associated with an individual patient and to further contextually alter the speech model. Further the one or more standardized medical attributes can also be utilized to transcribe speech into a common format (e.g., for display, or short or long term storage) and to achieve consistency in terminology.

Further, analysis engine 204 can also include format component 306 that transcribes speech or voice into text and provides a transcribed and/or formatted document that can be displayed for contemporaneous use or stored for subsequent utilization. Format component 306 can employ document formatting, signals (e.g., contractions, abbreviations, labels), and document conventions generally utilized within a particular profession (e.g., medical, legal, scientific, mathematical, . . . ). Further, format component 306 can also insert appropriate attributes (e.g., ICD-codes) into the formatted document, and where format component 306 is uncertain of an appropriate code or formatting convention it can solicit response from a human intermediary (e.g., the person dictating or speaking, or the person overseeing transcription of the audio file into text).

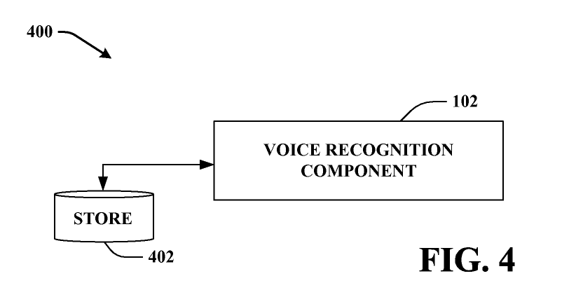

FIG. 4 depicts an aspect of a system 400 that improves speech recognition based at least in part on personal health records associated with a patient. System 400 can include store 402 that can include any suitable data necessary for voice recognition component 102 to facilitate it aims. For instance, store 402 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 402 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 402 of the subject systems and methods is intended to comprise, without being limited to, these and any other suitable types of memory. In addition, it is to be appreciated that store 402 can be a server, a database, a hard drive, and the like.

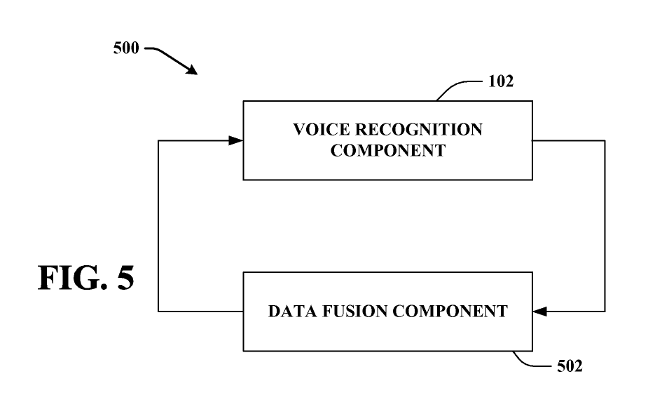

FIG. 5 provides yet a further depiction of a system 500 that improves speech recognition based at least in part on personal health records associated with a patient in accordance with an aspect of the claimed subject matter. As depicted, system 500 can include a data fusion component 502 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 502 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

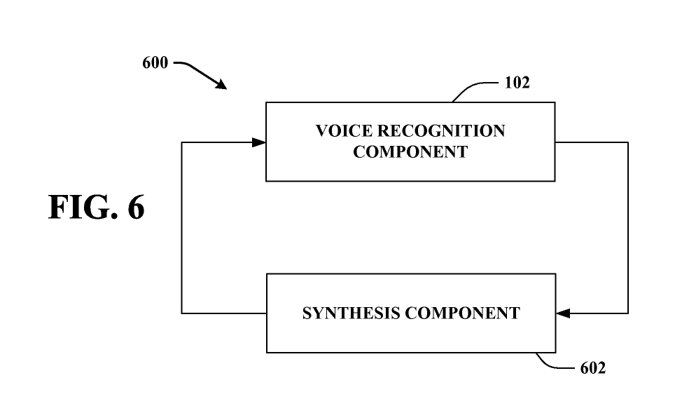

FIG. 6 provides a further depiction of a system 600 that improves speech recognition based at least in part on personal health records associated with a patient in accordance with an aspect of the claimed subject matter. As illustrated voice recognition component 102 can, for example, employ synthesis component 602 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesis component 602 through combining and filtering can provide a set of information that can be more informative, or accurate (e.g., with respect to an entity's communicative or informational goals) and information from just one or two modalities, for example. As discussed in connection with FIG. 5, the data fusion component 502 can be employed to learn correlations between different data types, and the synthesis component 602 can employ such correlations in connection with combining, or filtering the input data.

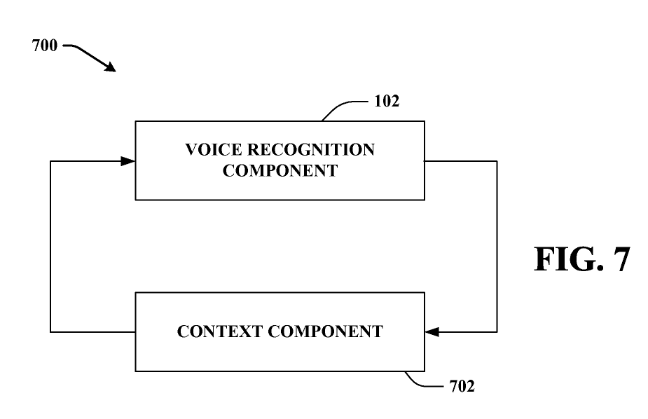

FIG. 7 provides a further illustration of a system 700 that improves speech recognition based at least in part on personal health records associated with a patient in accordance with an aspect of the claimed subject matter. As illustrated voice recognition component 102 can, for example, employ context component 702 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 702 can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, if the context component 702 had knowledge that the user was not camping, and that it was near dinnertime, the utterance would be interpreted as “steak”. On the other hand, if the context component 702 knew (e.g., via GPS system input) that the user recently arrived at a camping ground within a national park; it might more heavily weight the utterance as “stake”.

In view of the foregoing, it is readily apparent that utilization of the context component 702 to consider and analyze extrinsic information can substantially facilitate determining meaning of sets of inputs.

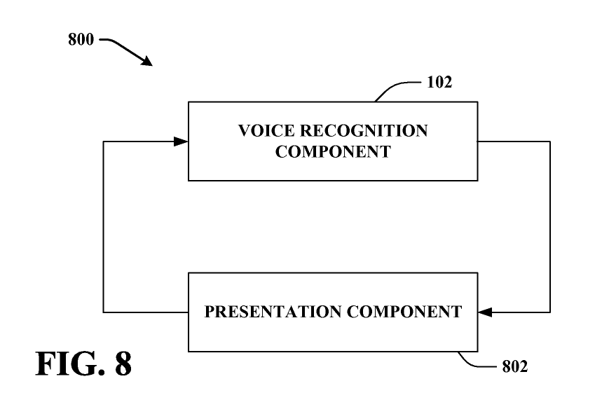

FIG. 8 provides further illustration of a system 800 that improves speech recognition based at least in part on personal health records associated with a patient in accordance with an aspect of the claimed subject matter. As illustrated, system 800 can include presentation component 802 that can provide various types of user interface to facilitate interaction between a user and any component coupled to voice recognition component 102. As illustrated, presentation component 802 is a separate entity that can be utilized with voice recognition component 102. However, it is to be appreciated that presentation component 802 and/or other similar view components can be incorporated into voice recognition component 102 and/or a standalone unit. Presentation component 802 can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into voice recognition component 102.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

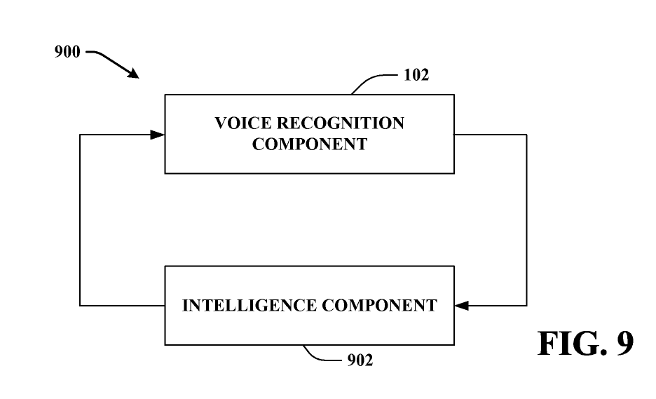

FIG. 9 depicts a system 900 that employs artificial intelligence to improve speech recognition based at least in part on personal health records associated with a patient in accordance with an aspect of the subject matter as claimed. Accordingly, as illustrated, system 900 can include an intelligence component 902 that can employ a probabilistic based or statistical based approach, for example, in connection with making determinations or inferences. Inferences can be based in part upon explicit training of classifiers (not shown) before employing system 100, or implicit training based at least in part upon system feedback and/or users previous actions, commands, instructions, and the like during use of the system. Intelligence component 902 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Intelligence component 902 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

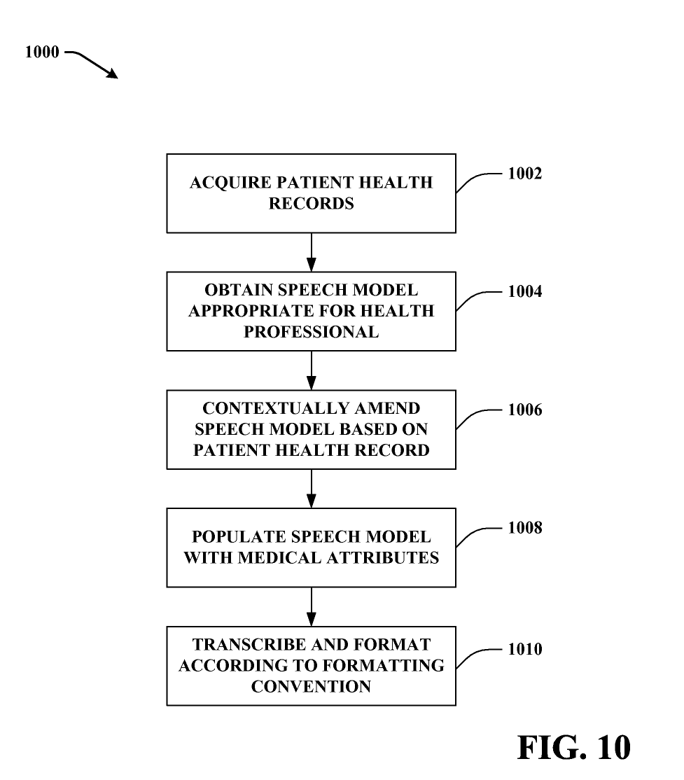

In view of the illustrative systems shown and described supra, methodologies that may be implemented in accordance with the disclosed subject matter will be better appreciated with reference to the flow chart of FIG. 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 10 depicts a machine implement methodology 1000 that improves speech recognition based at least in part on personal health records associated with a patient. Method 1000 can commence at 1002 where health records associated with a patient can be acquired. For example, health records (e.g., past and present medical complaints and ailments, laboratory reports, past and current heart rate, temperature, blood oxygen levels, drugs and herbal remedies taken, alternative health practitioners visited, diet, exercise regimes, and the like) can be obtained from personal health record manager 106. Moreover, given that personal health record manager 106 can typically have search capabilities, personal health record manager 106 can perform a data mining exercise based at least in part on the patient's health record to locate other medical artifacts (e.g., current research, clinical trials, and the like) associated with any disease that the patient has presented in the past or is currently presenting and that can be useful for medical practitioners in the diagnosis and treatment of disease.

At 1004 a speech model specific to the medical professional treating or investigating the disease can be acquired and loaded. For example, if Doctor Burette head of nephrology is the user, a speech model containing Doctor Burette's speech patterns together with phrases, synonyms, acrostics, mnemonics, etc. typically utilized in the field of nephrology can be acquired and loaded. It should be noted, without limitation, that the phases, synonyms, acrostics, mnemonic devices, and the like, are those typically employed in a particular field of specialty and can be based on a perceived level of competence associated with the medical practitioner; the more experience the medical professional is perceived to have the more compendious the acquired and loaded set of attributes (e.g., phases, synonyms, acrostics, mnemonic devices, . . . ). It should further be noted, once again without limitation, that the medical practitioner may never have actually utilized the acquired and/or loaded set of attributes in the past, but nevertheless, such acquired and loaded phases, synonyms, acrostics, mnemonic devices can currently be de rigueur in the field of specialty.

At 1006 the speech model can be amended based at least in part on the patient's health records acquired at 1002. For instance, if Patient Lo has been treated for melanoma and malaria in the past and is currently being treated for elephantiasis and trichinosis, a speech model reflective these ailments can be loaded thus amending the speech model utilized to specifically pertain to Patient Lo. To continue the foregoing example, if after Patent Lo has been seen by the medical professional, Patient Pimple presents with a case of acne, all the amendments to the speech model associated with Patient Lo can be expunged from the current speech model but persisted with Patient Lo's health records on personal health record manager 106, and the speech model can be amended with attributes associated with Patient Pimple's medical record obtained from personal health record manager 106.

At 1008 the speech model can be further amended to include internationally recognized disease and treatment codes. For example, seborrhoeic eczema has an ICD-10 code of L21, an ICD-9 code of 690, and a Disease Database code of 11911, whereas a sacrococcygeal fistula has an ICD-10 code of L05, an ICD-9 code of 685, and a Disease Database code of 31128. These disease and treatment codes can be utilized to appropriately populate the speech model with disease symptomologies, treatment options, and treatment outcomes, provide uniformity in transcription, as well as be employed to further data mine network topology and/or cloud 104 for further information regarding a patient's disease.

At 1010 speech uttered by the medical practitioner can be transcribed according to a prescribed formatting convention. Such a prescribed formatting convention can be based on international standard, a self-imposed standard, a professional standard, or be imposed by legislation, for example. Once transcribed according to a formatting convention the transcribed text can be presented (e.g., displayed on a monitor) to the medical practitioner for review or can be associated with the appropriate patient health record and persisted to storage media (e.g., personal health record manager 106) for subsequent utilization.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

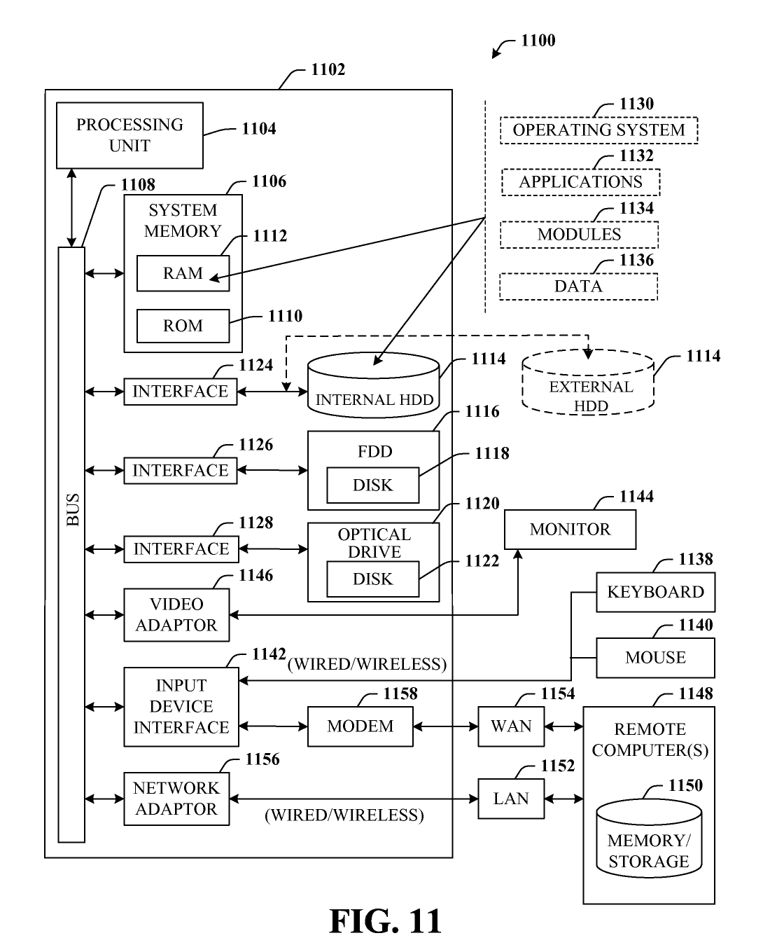

Referring now to FIG. 11, there is illustrated a block diagram of a computer operable to execute the disclosed system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the illustrative environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1094 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are illustrative and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

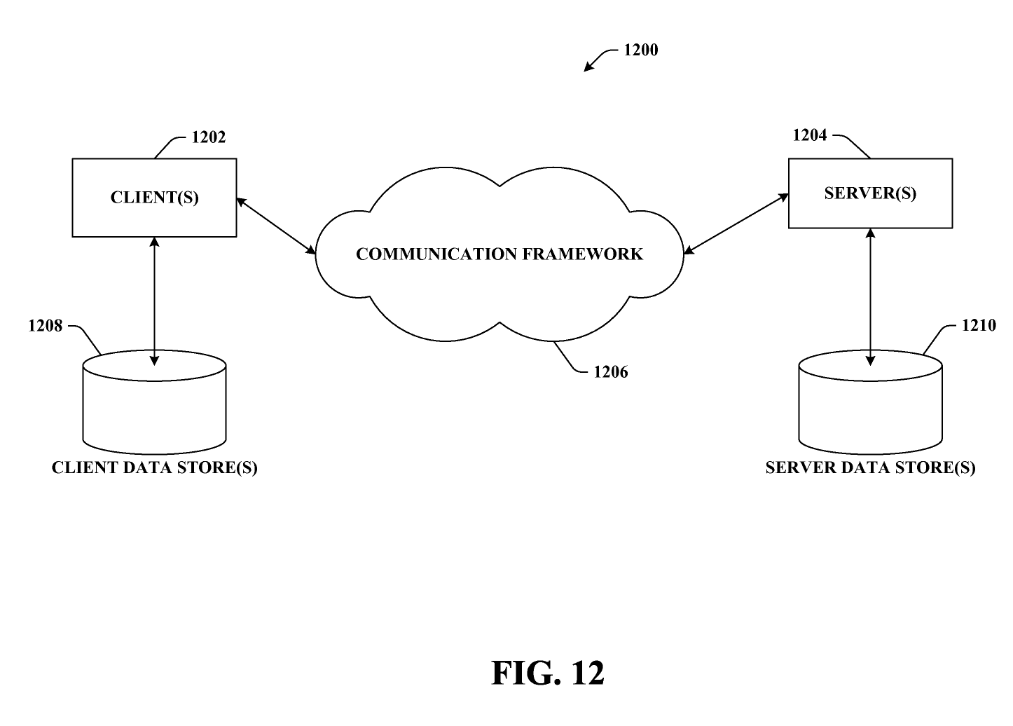

Referring now to FIG. 12, there is illustrated a schematic block diagram of an illustrative computing environment 1200 for processing the disclosed architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that improves speech recognition, comprising:
a component that accesses via an interface a personal health record associated with a patient, the component analyzes the personal health record for at least one of a current disease or a past ailment, acquires an attribute or a variant of the attribute associated with the current disease or the past ailment, dynamically populates a recognition component with the attribute or the variant of the attribute associated with the current disease or the past ailment, the recognition component utilizes the attribute or the variant of the attribute to transcribe a voice pattern into text projected on a visual display or persisted to a storage device.

2. The system of claim 1, the component dynamically modifies the recognition component based at least in part on a speech pattern associated with a healthcare professional.

3. The system of claim 1, the component automatically modifies the recognition component based at least in part on a level of experience associated with a healthcare professional.

4. The system of claim 1, the component modifies the recognition component based on a medical specialty associated with a healthcare professional.

5. The system of claim 1, the component facilitates a search for a medically recognized code, the medically recognized code employed by the recognition component to standardize the text projected on the visual display or persisted to the storage device.

6. The system of claim 1, the component expunges entirely from the recognition component the attribute or the variant of the attribute associated with the current disease or the past ailment obtained from the personal health record associated with the patient and replaces the attribute or the variant of the attribute associated with the current disease or the past ailment with a second attribute or a variant of the second attribute associated with another personal health record associated with a second patient.

7. The system of claim 1, the recognition component upon receipt of the voice pattern contemporaneously modifies the voice pattern to conform to a prescribed transcription formatting standard, the prescribed transcription formatting standard based at least in part on a universally recognized medical code.

8. A method implemented on a machine that improves speech recognition, comprising:
obtaining a personal health record associated with a patient;
analyzing the personal health record for at least one of a current disease or a past ailment;
extracting an attribute or a variant of the attribute associated with the current disease or the past ailment from the personal health record;
populating a recognition component with the attribute or the variant of the attribute associated with the current disease or the past ailment;
transcribing a voice pattern into text based at least in part on the attribute or the variant of the attribute; and
projecting the text onto a visual display for confirmation of accuracy by an intermediary associated with the voice pattern, and based on the confirmation of accuracy persisting the text to local or remote storage media.

9. The method of claim 8, the populating further comprising modifying the recognition component based at least in part on the voice pattern associated with the intermediary.

10. The method of claim 8, the populating further comprising modifying the recognition component based at least in part on a level of experience associated with the intermediary.

11. The method of claim 8, the populating further comprising amending the recognition component based on a medical functionality associated with the intermediary.

12. The method of claim 8, further comprising initiating a search for a medically recognized code employed to standardize text transcription.

13. The method of claim 8, the populating further comprising:
removing from the recognition component all aspects associated with the attribute or the variant of the attribute associated with the current disease or the past ailment obtained from the personal health record associated with the patient; and
substituting the attribute or the variant of the attribute associated with the current disease or the past ailment with a second attribute or a variant of the second attribute associated with another personal health record associated with a second patient.

14. The method of claim 8, the transcribing further comprising upon receipt of the voice pattern modifying the voice pattern to conform to a prescribed transcription formatting standard, the prescribed transcription formatting standard based at least in part on a universally recognized set of medical codes.

15. A system that improves speech recognition, comprising:
means for populating a recognition component with an attribute or a variant of the attribute associated with at least one of a current disease or a past ailment retrieved from a personal health record;
means for transcribing a voice pattern into text based at least in part on the attribute or the variant of the attribute associated with at least one of the current disease or the past ailment; and
means for displaying the text onto a visual display for confirmation of accuracy by an intermediary associated with the voice pattern.

16. The system of claim 15, further comprising means for removing from the recognition component all aspects associated with the attribute or the variant of the attribute associated with the current disease or the past ailment obtained from the personal health record associated with the patient.

17. The system of claim 15, further comprising means for substituting the attribute or the variant of the attribute associated with the current disease or the past ailment with a second attribute or a variant of the second attribute associated with another personal health record associated with a second patient.

18. The system of claim 15, further comprising means for modifying the voice pattern to conform to a prescribed transcription formatting standard, the prescribed transcription formatting standard based at least in part on a universally recognized set of medical codes.

19. The system of claim 15, the means for populating modifies the recognition component based at least in part on a level of experience associated with the intermediary.

20. The system of claim 15, the means for transcribing modifies the voice pattern upon receipt to conform to a prescribed transcription formatting standard, the prescribed transcription formatting standard based at least in part on a universally recognized set of medical codes.
